(19) United States
(12) Patent Application Publication
(10) Pub. No.: US 2009/0064111 A1
(43) Pub. Date: Mar. 5, 2009

(54) Formal Verification of Graphical Programs

(76) Inventors: Jacob Kornerup, Austin, TX (US); Grant O. Passmore, Sugar Land, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/834,084

(22) Filed: Aug. 6, 2007

Related U.S. Application Data
(60) Provisional application No. 60/821,679, filed on Aug. 7, 2006.

(51) Int. Cl. G06F 9/44

(52) U.S. Cl. 717/126

(57) ABSTRACT

System and method for formal verification of a graphical program. A graphical program comprising a plurality of interconnected nodes is created in response to input. One or more correctness assertions regarding program state of the graphical program are specified in response to user input, and a proof obligation generated based on the graphical program and the correctness assertions, which is usable by a theorem prover to determine correctness of the graphical program. The proof obligation may be generated by compiling the graphical program to generate an object-level diagram, parsing the correctness assertions to generate an intermediate logical form of the one or more correctness assertions, and analyzing the object-level diagram, the intermediate logical form, and/or semantics of the graphical programming language in which the graphical program is written to generate the proof obligation. A theorem prover may then process the proof obligation to determine whether the graphical program is correct.

### PRIORITY DATA

This application claims benefit of priority to U.S. Provisional Application 60/821,679, titled “Formal Verification of Graphical Programs”, filed Aug. 7, 2006, and whose inventors were Jacob Kornerup and Grant O. Passmore.

### FIELD OF THE INVENTION

The present invention relates to the field of graphical programming, and more particularly to a system and method for formal verification of graphical programs.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

As programs have become ubiquitous in many areas of human endeavor, including, for example, telecommunications, manufacturing, medicine, and transportation, and especially in mission-critical applications, it has become increasingly important that the functionality and behavior of the programs be verified, i.e., that the functionality and behavior of the programs be shown to be as intended. However, as programs have become increasingly complex, it has become increasingly difficult to perform such verification.

Generally, software testing has been the only available method for program verification, especially regarding graphical programs. Such program testing attempts to search the state space of the program (including data) to determine illegal or improper states that correspond to errors or bugs in the program, which may be semantic and/or syntactical in nature. However, due in large part to the generally overwhelming magnitude of the state space for any but the simplest of programs, such software testing is neither exhaustive nor particularly reliable. For example, it has been noted that the state space of possible execution traces in most programs has more possible paths than there are electrons in the universe, and so exhaustive testing to cover this space is not feasible, or even possible. Thus, software testing is not exhaustive, and cannot generally provide confirmation that applications are correct or predictable. Stated another way, testing can be used to detect errors in a program, but not in asserting that the program is error-free.

Another approach to program verification based is based on actually proving the correctness of programs, referred to as formal program verification, and is more mathematical in nature. While formal proof-based program verification has been studied for some time in academic contexts, such systems are typically arcane and difficult to use, and thus have not been available or useful for general use. Moreover, such formal program verification systems have not been developed for graphical programming systems, such as LabVIEW.

Thus, systems and methods for formal verification of graphical programs are desired.

### SUMMARY OF THE INVENTION

Various embodiments of a system and method for formal verification of graphical programs are presented below. A graphical program may be created on a computer system in response to input, e.g., in response to user input. The graphical program may include a plurality of interconnected nodes or icons which visually indicates the functionality of the program. The graphical program may include a block diagram and may also include a user interface portion or front panel portion. As one example, the user may use the LabVIEW graphical programming development environment to create the graphical program. The graphical program may be generated manually, or programmatically or automatically based on other entities as desired, e.g., based on a program specification or another program.

One or more correctness assertions regarding program state of the graphical program may be specified in response to user input. For example, the one or more correctness assertions may include or be in the form of annotations in the graphical program. For example, in one embodiment, the user may specify various assertions in the form of alphanumeric logical assertions, e.g., “ASSERT(X+Y<=1.0), although this assertion is meant to be exemplary only, and is not intended to limit the form or function of the assertions to any particular type. As another example, the one or more correctness assertions may include or have the form of a plurality of interconnected nodes that indicate or specify the correctness assertions regarding program state of the graphical program. In other words, the correctness assertions may be specified graphically, e.g., by graphical program code, in the same or in a similar manner as the graphical program. In preferred embodiments, both the graphical program and the correctness assertions may be specified by LabVIEW graphical program code. In one embodiment, the plurality of interconnected notes that visually indicate functionality of the graphical program may be comprised in a block diagram of the graphical program, and the plurality of interconnected nodes that indicate the correctness assertions may be included in a theorem block included in or coupled to the block diagram. Of course, in other embodiments, the assertions may be implemented in other forms, e.g., text-based program code, macros, and so forth, as desired. In some embodiments, the theorem block may include a bounding border or structure, e.g., a rectangle with an interior portion, within which the correctness assertions may be placed.

In preferred embodiments, specifying the one or more correctness assertions regarding program state of the graphical program in response to user input may include: including a theorem block in the graphical program in response to first user input, and including the one or more correctness assertions in the theorem block in response to second user input. In various embodiments, the second user input may include user input selecting the one or more correctness assertions from one or more of: one or more palettes, one or more menus, or one or more dialogs, among other selection means. For example, in embodiments where the one or more correctness assertions include graphical program code, e.g., a second plurality of interconnected nodes that visually indicate the one or more correctness assertions, the second user input may include user input dragging and dropping the graphical program code into the theorem block. In other words, the user may, for example, drag and drop nodes (possibly themselves representing respective pluralities of interconnected nodes) from a palette onto the graphical program, e.g., into the theorem block.

In some embodiments, the method may include specifying one or more portions of the graphical program to verify in response to user input. In other words, the user may indicate, e.g., via a pointing device such as a mouse, which portion or portions of the graphical program are to be verified. For example, the user may select the graphical program portions to be verified by drawing a respective bounding rectangle (separate and distinct from the theorem block) around each portion to be verified.

In various embodiments, the plurality of assertions may specify any logical, semantic, or timing (or other type of) assertion, among others. For example, in some embodiments, the plurality of assertions may specify one or more of: invariance of one or more logical predicates regarding the graphical program, temporal logical relationships of the graphical program, pre-conditions of the graphical program, post-conditions of the graphical program, timing properties of the graphical program, one or more safety properties of the graphical program, and/or one or more progress properties of the graphical program, among others. For example, a property P is invariant in a program A if P holds in all relevant states of any execution of A, e.g., for an elevator control program: “0<cab.position<=8”, or “NOT(cab.moving AND doors.open)”, and so forth. As another example, pre-/post-conditions for the program, may be specified by Hoare Triples: {P} S {Q}, meaning that if the program starts in a state where P is true, then execution of statement S results in a state where Q is true. Examples of assertions using Hoare Triples include: “{a>0} x:=a {x>0}” and, in a more complex case: “{TRUE} if x>y then max:=x else max:=y {max=MAX(x, y)}”, although it should be noted that these examples are exemplary only. An example of a liveness property is: cab.request=2 leads-to cab.position=2, stating that once the elevator has been requested on floor number 2, it will eventually be at floor number 2.

As used herein, a timing property relates the execution of the program to an underlying clock that times the execution of the program or a different clock timing any potential IO that the system performs. For example, the clocks for IO may be independent from the clock driving the program. In one embodiment, the graphical program language may be extended with a function (node), e.g., called clock, that may be used to access the current value of the underlying system clock driving the execution of the program. An example of a timing property is: {digital_in_line_{—}0=high AND clock=k} P {digital_out_line_{—}5=low AND clock <=k+5 ticks}, asserting that a program P introduces a delay of no more than 5 clock ticks in the output on a digital line. In other embodiments, the value of other system timing engines, such as data acquisition timers, may be exposed as function nodes, available as both programming language constructs and for specifying timing properties of the data acquisition system, realized by a program. Thus, a theorem block may be used to assert timing behavior of a block diagram.

As used herein, a safety property states, indicates, or asserts that “the program does no harm”. A safety property can be checked on each program state in isolation, e.g., in an appropriately configured theorem block. As used herein, a progress property states, indicates, or asserts that “the program does some good”, i.e., accomplishes something. Note that in some embodiments, a progress property can only be checked on all the states of a (partial) execution. Thus, in various embodiments, the graphical program or block diagram may include or be coupled to a theorem block that implements an assertion regarding the behavior of the graphical program or block diagram.

A proof obligation may be generated based on the graphical program and the one or more correctness assertions, where the proof obligation is usable by a theorem prover to determine whether the graphical program is correct (or not). A proof obligation refers to a collection or set of statements which may be proved correct or incorrect, e.g., by a theorem prover, in the context of a system, in this case, a graphical program.

Note that there are a variety of different theorem provers that may be used in different embodiments of the present invention, and the particular form of the proof obligation may depend on the type of theorem prover to be used. For example, there are theorem provers that operate at different orders of mathematical logic. Thus, for example, in some embodiments, the proof obligation may be generated in or at a first order of mathematical logic, e.g., axiomatic mathematical logic, which may be usable by a first order theorem prover to prove correctness of the graphical program. Of course, in other embodiments, the proof obligation may be generated in or at higher orders of mathematical logic, e.g., second, third, fourth, and so forth, orders of mathematical logic, and so may be solvable or processed by higher order theorem provers.

Note also that there are various types of proof obligations that may rely on different types of logic, and/or on different formal systems. For example, types of logic that may be used include, but are not limited to, modal logic, temporal logic, lambda calculas, or Hoare logic, among others. As is well-known in the art of proofs, types of proof obligations include, but are not limited to, number-theoretic proof obligations dealing with properties of the natural counting numbers, e.g., utilizing mathematical induction, modal temporal proof obligations specifically addressing properties of timing and program flow in a modal temporal logic, and so forth. Thus, in various embodiments, the proof obligation may be or include any of various types of proof obligation, including one or more of: a number theoretic proof obligation requiring only term rewriting, a number theoretic proof obligation requiring mathematical induction, a list theoretic proof obligation in accordance with a formal theory of finite lists, a floating point proof obligation in accordance with a formal theory of floating point numbers, or a bit vector proof obligation in accordance with a formal theory of bit vectors, among others. Note that any combination of different types of proof obligation may be used as desired.

In embodiments where the user has specified portions of the graphical program for verification, generating the proof obligation based on the graphical program and the one or more correctness assertions may include generating the proof obligation based on one or more specified portions of the graphical program and the one or more correctness assertions. In other words, the proof obligation may only be directed to those portions of the graphical program specified by the user.

In one embodiment, generating a proof obligation based on the graphical program and the one or more correctness assertions may include compiling the graphical program to generate an object-level diagram, parsing the one or more correctness assertions to generate an intermediate logical form of the one or more correctness assertions, and analyzing the object-level diagram and the intermediate logical form to generate the proof obligation.

As is well known, the graphical program is written in a graphical programming language, e.g., under a graphical programming development environment, such as LabVIEW, Simulink, VEE, or another graphical programming development environment, where the graphical programming language has semantics that express or govern proper or legal operations and/or constructs for programs developed in the language. In some embodiments, analyzing the object-level diagram and the intermediate logical form to generate the proof obligation may include analyzing the object-level diagram, the intermediate logical form, and an axiomatized description of semantics of the graphical programming language to generate the proof obligation. In other words, the semantics of the graphical programming language may be expressed in a form suitable for analysis, and analyzed along with the object-level diagram and the intermediate logical form to generate the proof obligation.

In some embodiments, a theorem prover may process the proof obligation to determine program correctness, i.e., whether the graphical program is correct or not, e.g., whether the program generates the correct result, and/or operates in a correct manner. Said another way, the theorem prover may determine if the graphical program is consistent with the one or more correctness assertions. In some embodiments, the theorem prover processing the proof obligation to determine whether the graphical program is correct may include the theorem prover attempting to determine a proof of the correctness of the graphical program.

If the theorem prover fails to prove program correctness, the theorem prover may provide information indicating where the proof of program correctness failed. For example, the information indicating where the proof of program correctness failed may include information indicating that the proof of program correctness failed at a location in one or more of: the proof obligation, or the graphical program. In other words, feedback may be provided to the user indicating or hinting at where problems with the program correctness are. In some embodiments, information indicating possible avenues for correcting the graphical program may be provided. The user may then modify the graphical program and/or the correctness assertions, and repeat the above-described process as desired. The above process may thus be performed in an iterative manner until the graphical program is proven to be correct.

In some embodiments, the correctness assertions may also be included as part of the program at run-time as program assertions that must hold during execution. If an assertion fails to hold at run-time, the user may indicate that the program should stop, or the user may indicate that such a failure should be recorded in a log while the program continues to run. In some embodiments, each correctness assertion may simply be used “as is” in the graphical program. For example, if the assertions are implemented in a programming language that may be executed with the graphical program, e.g., as part of the graphical program, then no conversion may be required. Alternatively, in other embodiments, the assertions may be converted to such program code, e.g., graphical program code or text-based code, and executed with or as part of the graphical program. Note that in various embodiments, this conversion may be performed by the user, or may be performed automatically, as desired. In some embodiments, the correctness assertions may be used as run-time assertions that may be used as supplements to, or as a substitute for, formal verification by a theorem prover.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program according to an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method for formal verification of a graphical program;

FIG. 6 is an exemplary block diagram with a theorem block, according to one embodiment; and

FIG. 7 is another exemplary block diagram with a theorem block directed to timing behavior of a graphical program, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference:

The following references are hereby incorporated by reference in their entirety as though fully and completely set forth herein:

U.S. Provisional Application 60/821,679, titled “Formal Verification of Graphical Programs”, filed Aug. 7, 2006.

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium that conveys signals such as electrical, electromagnetic, or digital signals, such as a bus, network and/or other physical transmission medium.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Graphical User Interface Element—an element of a graphical user interface, such as for providing input or displaying output. Exemplary graphical user interface elements comprise input controls and output indicators

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

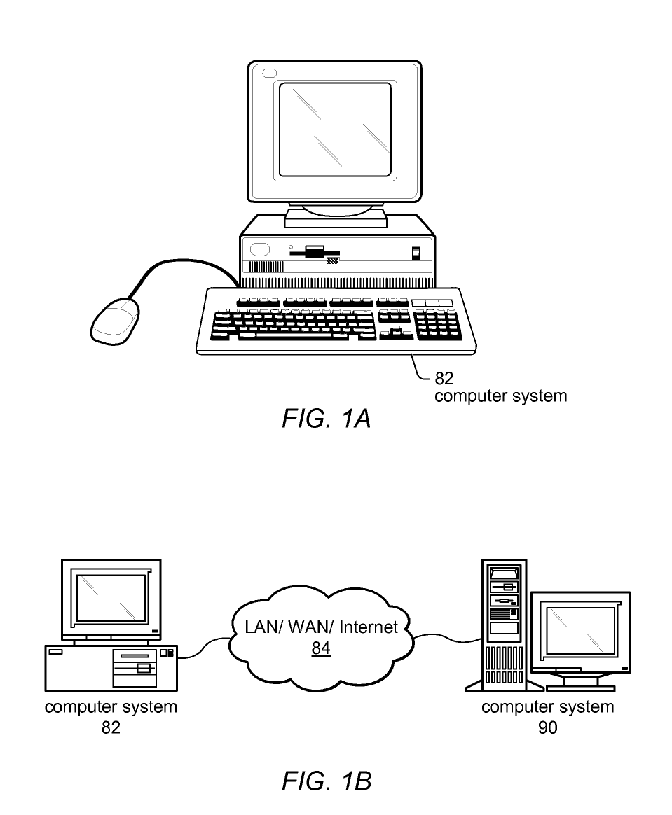

### FIG. 1A—Computer System

FIG. 1A illustrates a computer system 82 operable to implement various embodiments of the present invention. Embodiments of a method for formal verification of graphical programs are described below.

As shown in FIG. 1A, the computer system 82 may include a display device operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more graphical programs which are executable to perform the methods described herein. Additionally, the memory medium may store a graphical programming development environment application used to create and/or execute such graphical programs. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

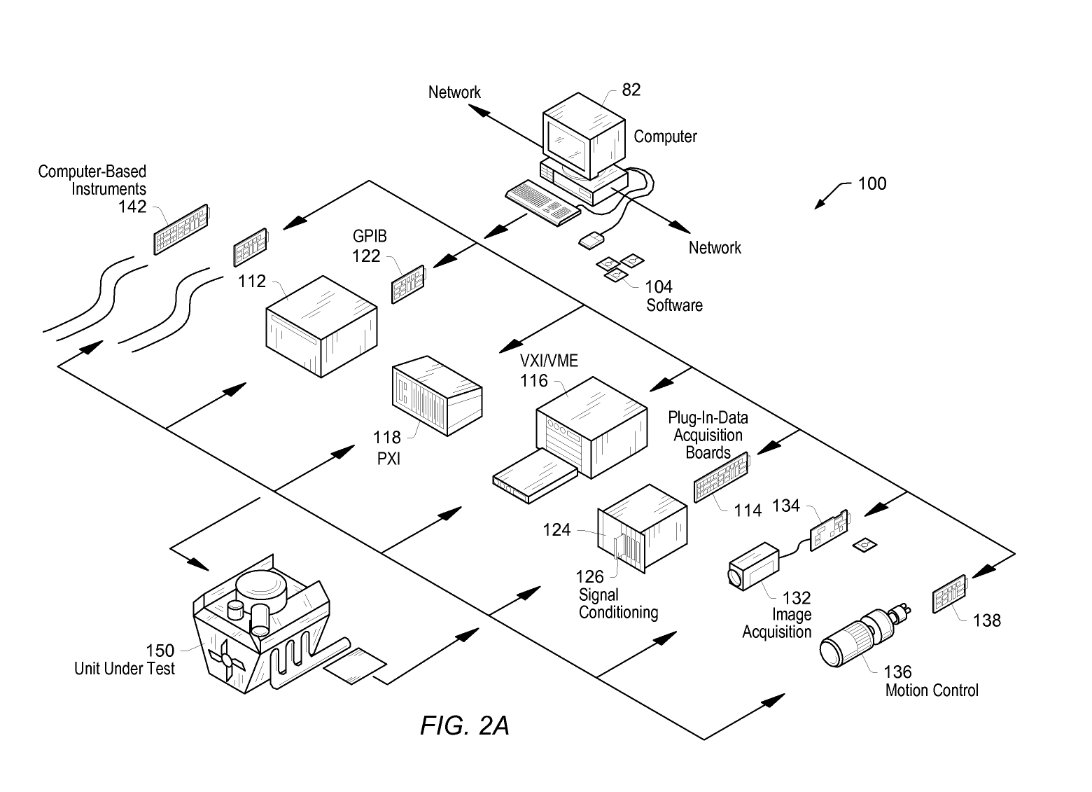

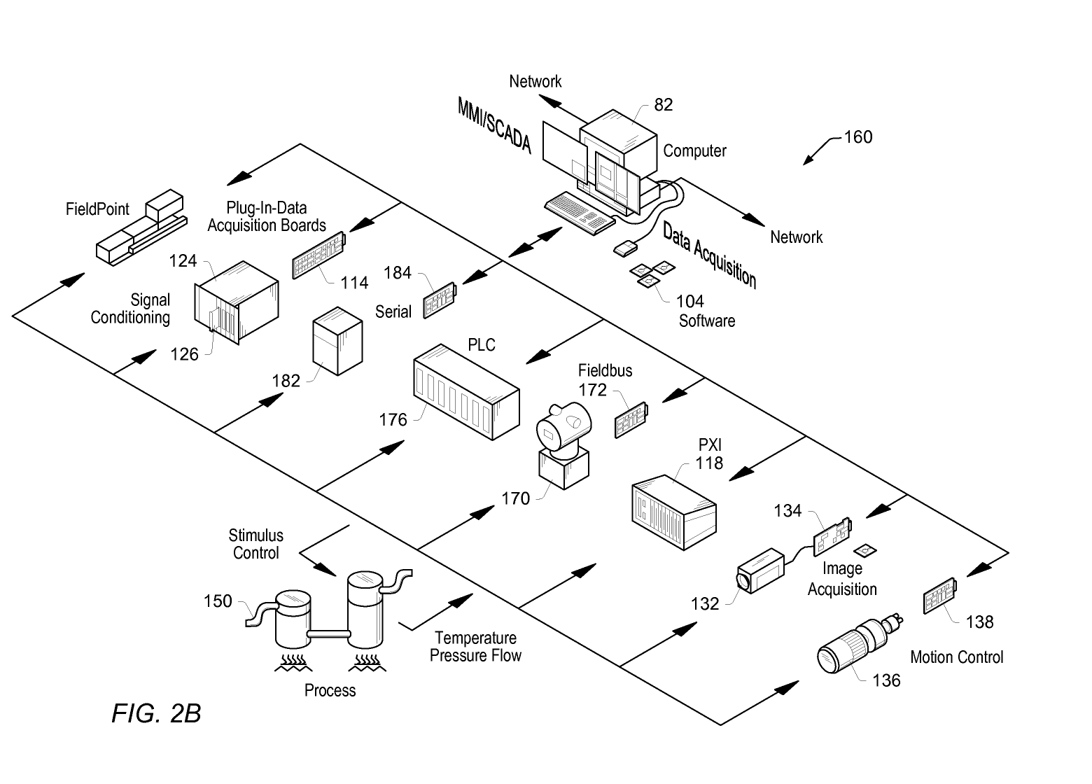

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

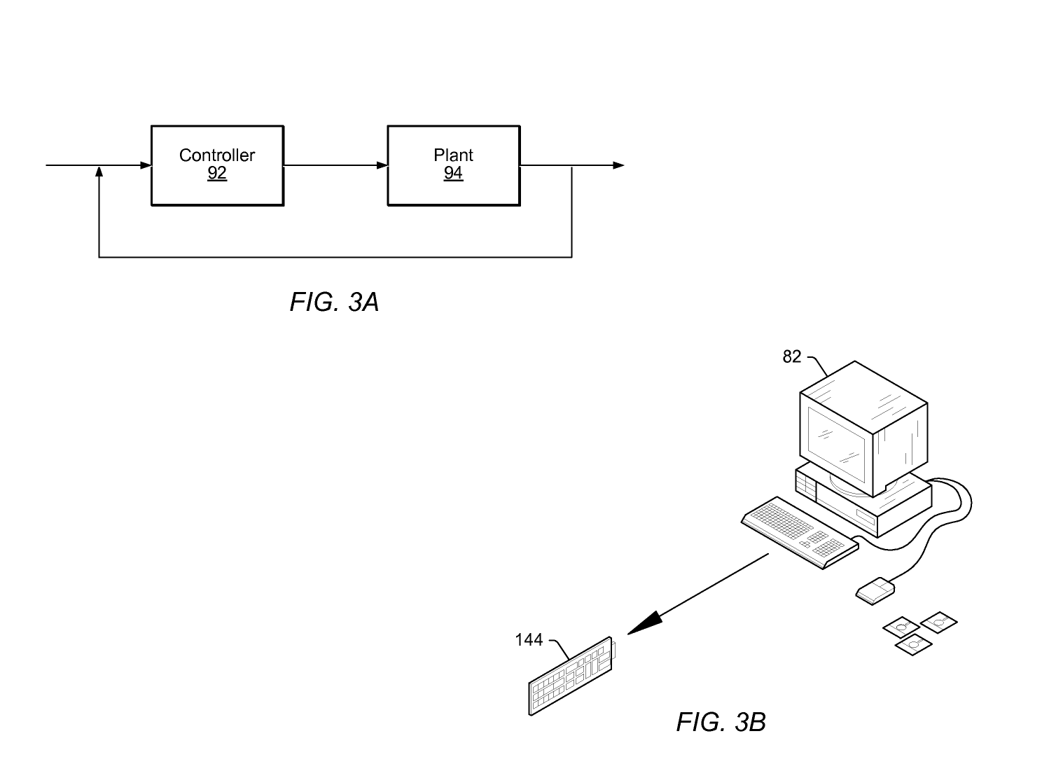

FIG. 3A is a high level block diagram of an exemplary system which may execute or utilize graphical programs. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

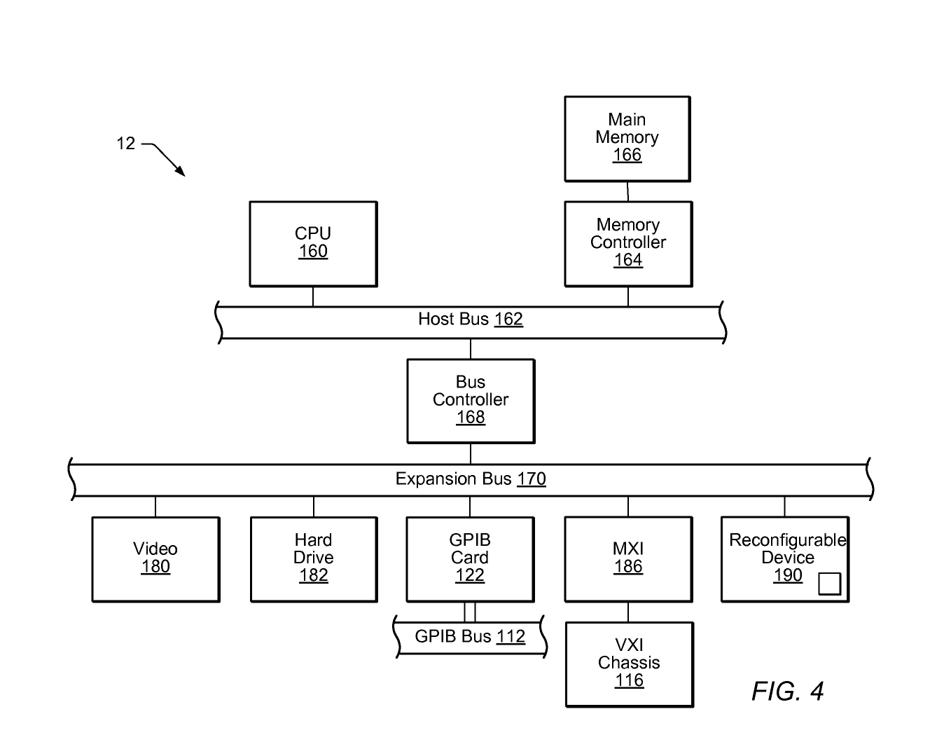

### FIG. 4—Computer System Block Diagram

FIG. 4 is a block diagram representing one embodiment of the computer system 82 and/or 90 illustrated in FIGS. 1A and 1B, or computer system 82 shown in FIGS. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store software for performing formal verification of graphical programs, as well as the graphical program or programs themselves. In some embodiments, the main memory 166 may also a theorem prover, although in other embodiments, the theorem prover may be stored on an external system, e.g., coupled to the computer system 82 via a network. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. The computer system may be operable to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

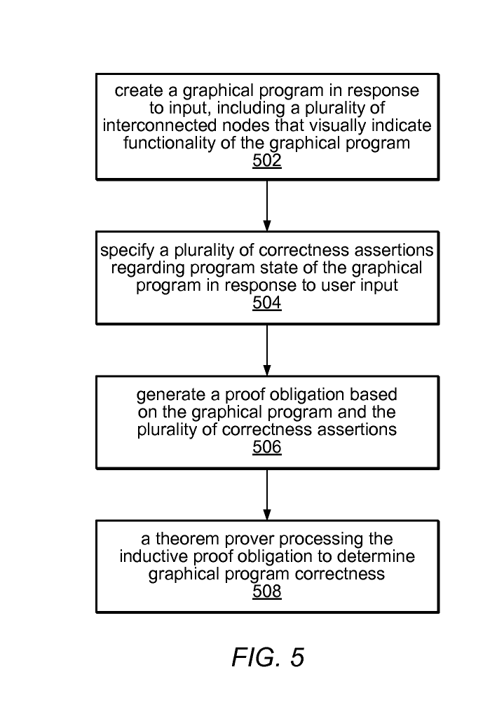

### FIG. 5—Flowchart of a Method for Formal Verification of a Graphical Program

FIG. 5 illustrates one embodiment of a method for formal verification of a graphical program. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 502 a graphical program may be created on the computer system 82 (or on a different computer system) in response to input, e.g., in response to user input. The graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. As noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program. a

In an alternate embodiment, the graphical program may be created in 502 by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function that is desired to be performed by the instrument.

In other embodiments, the graphical program may be generated programmatically or automatically based on other entities as desired, e.g., based on a program specification or another program.

In 504, one or more correctness assertions regarding program state of the graphical program may be specified in response to user input. For example, the one or more correctness assertions may include or be in the form of annotations in the graphical program. For example, in one embodiment, the user may specify various assertions in the form of alphanumeric logical assertions, e.g., “ASSERT(X+Y<=1.0), although this assertion is meant to be exemplary only, and is not intended to limit the form or function of the assertions to any particular type.

As another example, the one or more correctness assertions may include or have the form of a plurality of interconnected nodes that indicate or specify the correctness assertions regarding program state of the graphical program. In other words, the correctness assertions may be specified graphically, e.g., by graphical program code, in the same or in a similar manner as the graphical program. In preferred embodiments, both the graphical program and the correctness assertions may be specified by LabVIEW graphical program code. In one embodiment, the plurality of interconnected notes that visually indicate functionality of the graphical program may be comprised in a block diagram of the graphical program, and the plurality of interconnected nodes that indicate the correctness assertions may be included in a theorem block included in or coupled to the block diagram. Of course, in other embodiments, the assertions may be implemented in other forms, e.g., text-based program code, macros, and so forth, as desired. In some embodiments, the theorem block may include a bounding border or structure, e.g., a rectangle with an interior portion, within which the correctness assertions may be placed.

In preferred embodiments, specifying the one or more correctness assertions regarding program state of the graphical program in response to user input may include: including a theorem block in the graphical program in response to first user input, and including the one or more correctness assertions in the theorem block in response to second user input. In various embodiments, the second user input may include user input selecting the one or more correctness assertions from one or more of: one or more palettes, one or more menus, or one or more dialogs, among other selection means. For example, in embodiments where the one or more correctness assertions include graphical program code, e.g., a second plurality of interconnected nodes that visually indicate the one or more correctness assertions, the second user input may include user input dragging and dropping the graphical program code into the theorem block. In other words, the user may, for example, drag and drop nodes (possibly themselves representing respective pluralities of interconnected nodes) from a palette onto the graphical program, e.g., into the theorem block.

In some embodiments, the method may include specifying one or more portions of the graphical program to verify in response to user input. In other words, the user may indicate, e.g., via a pointing device such as a mouse, which portion or portions of the graphical program are to be verified. For example, the user may select the graphical program portions to be verified by drawing a respective bounding rectangle (separate and distinct from the theorem block) around each portion to be verified.

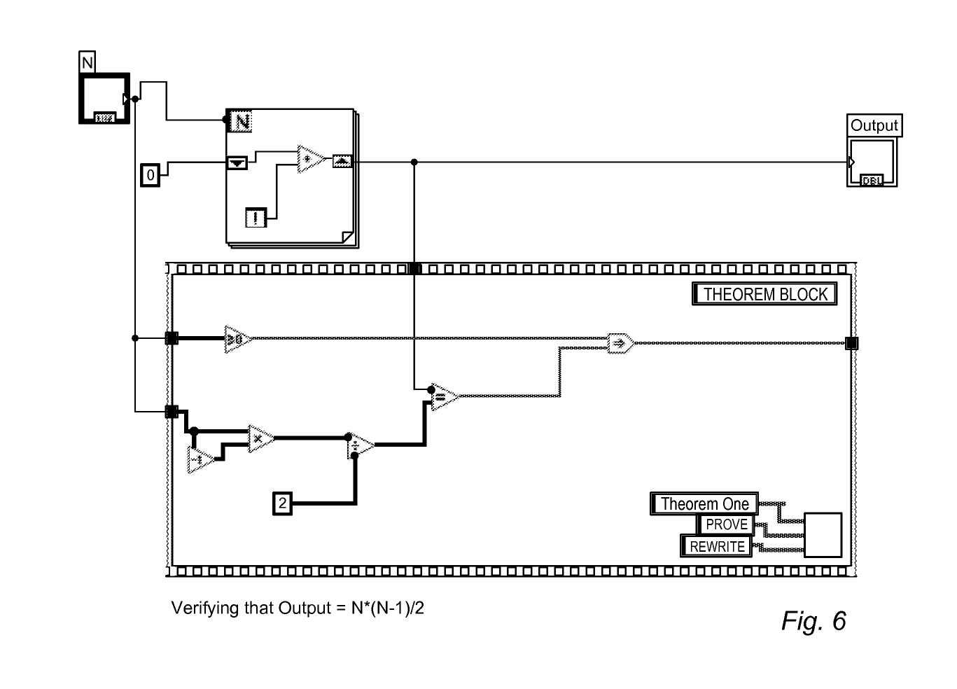

FIG. 6 is an exemplary block diagram that includes a theorem block, according to one embodiment. As FIG. 6 shows, in this example, the functional portion of the block diagram (i.e., not the theorem block portion) implements an algorithm that computes the sum of a sequence of integers ranging from 0 to N−1 via a loop structure, where N denotes or specifies the number of iterations of the loop. As the functional portion of the block diagram indicates, a front panel terminal (node) in the top left-hand portion of the diagram provides a value for N, while a constant “0” specifies the initial value of the sum, i.e., prior to any iterations. As shown, these two values are input to a loop structure that iteratively adds the loop count (which ranges from 0 to N−1) to the sum, and outputs the result (after N iterations) to an output terminal, labeled “Output”, e.g., whereby the output may be displayed on a front panel or other GUI of the graphical program.

As may be seen in FIG. 6, a theorem block, so labeled, is coupled to or included in the block diagram, and includes a correctness assertion as to the results of the computation of the functional portion of the block diagram. More specifically, the theorem block asserts that the iterative computation result should be equal to the expression “N(N−1)/2”. Note that, as with the functional portion of the block diagram, in this expression N is the loop control variable specifying the number of iterations to perform, not the upper bound value of the counting variable (in which case, the expression would be “N(N+1)/2”, as is well known). Thus, the theorem block makes an assertion as to what the correct result of the functional portion of the block diagram should be. Thus, in this example, the theorem block makes an auxiliary (alternative) computation that should agree with that of the functional portion of the block diagram. In the case when a theorem of equality between the result of the program and a closed formula has been proven, it may be possible to replace the program with this closed form. In this example, the For loop could be replaced at run-time under the user's direction, with the (equivalent, but more efficient) calculation N*(N−1)/2.]

Note, however, that in various embodiments, the plurality of assertions may specify any logical, semantic, or timing (or other type of) assertion, among others. For example, in some embodiments, the plurality of assertions may specify one or more of: invariance of one or more logical predicates regarding the graphical program, temporal logical relationships of the graphical program, pre-conditions of the graphical program, post-conditions of the graphical program, timing properties of the graphical program, one or more safety properties of the graphical program, and/or one or more progress properties of the graphical program, among others. For example, a property P is invariant in a program A if P holds in all relevant states of any execution of P, e.g., for an elevator control program: “0<cab.position <=8”, or “NOT(cab.moving AND doors.open)”, and so forth. As another example, pre-/post-conditions for the program, may be specified by Hoare Triples: {P} S {Q}, meaning that if the program starts in a state where P is true, then execution of statement S results in a state where Q is true. Examples of assertions using Hoare Triples include: “{a>0} x:=a {x>0}” and, in a more complex case: “{TRUE} if x>y then max:=x else max:=y {max=MAX(x, y)}”, where MAX is a mathematical function of two arguments returning the maximum value of these two arguments, although it should be noted that these examples are exemplary only. An example of a liveness property is: cab.request=2 leads-to cab.position=2, stating that once the elevator has been requested on floor number 2, it will eventually be at floor number 2.

As used herein, a timing property relates the execution of the program to an underlying clock that times the execution of the program and any potential IO that the system performs. In one embodiment, the graphical program language may be extended with a function (node), e.g., called clock, that may be used to access the current value of the underlying system clock. An example of a timing property is: {digital_in_line_{—}0=high AND clock=k} P {digital_out_line_{—}5=low AND clock <=k+5 ticks}, asserting that a program P introduces a delay of no more than 5 clock ticks in the output on a digital line, from the point when the input line goes low. In other embodiments, the value of other system timing engines, such as data acquisition timers, may be exposed as function nodes, available as both programming language constructs and for specifying timing properties of the data acquisition system, realized by a program.

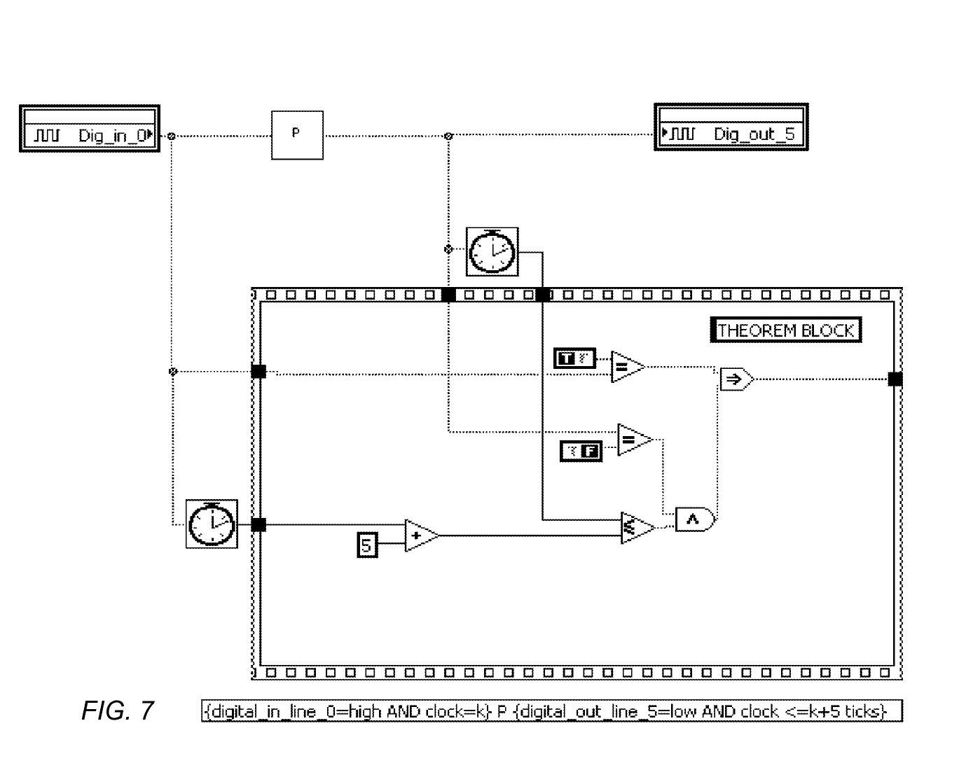

FIG. 7 is an exemplary block diagram that includes a theorem block directed to timing, according to one embodiment. As FIG. 7 shows, in this example, a digital input line, labeled Dig_in_{—}0 (top left of diagram) provides input to a graphical program P (rectangular node labeled “P”), which then provides output via a digital output line, labeled “Dig_out_{—}5” (top right of diagram). Note that graphical program P, here represented by a single icon or node, preferably includes a plurality of interconnected nodes that visually represent functionality of the program. A node that represents such a program, such as P, may be referred to as a sub-VI.

As may be seen, this diagram also includes a theorem block, so labeled, configured to assert a specified timing behavior for the block diagram, particularly for program P. More specifically, the theorem block makes an assertion regarding the maximum time delay introduced between the diagram's input and output by the graphical program P.

As FIG. 7 shows, wires branching from the block diagram both before and after node P, i.e., Dig_in_{—}0 and Dig_out_{—}5, are routed to the theorem block, each coupling to or passing through a respective clock node, shown by a clock icon, before entering the theorem block. The clock nodes may be executable to time-stamp data on the wires prior to provision of the data to the theorem block. Note that because the two data paths traversing the clock nodes respectively originate from before and after the graphical program P, the two timestamps differ by the delay introduced by the graphical program P. As may be seen, the theorem block asserts that this delay does not exceed 5 ticks. This is accomplished by adding 5 clock ticks to the Dig_in_{—}0 data (timestamp), then comparing the result with the timestamp of the Dig_out_{—}5 data, and generating a logical value indicating whether the assertion holds, i.e., whether the Dig_in_{—}0 timestamp and the Dig_out_{—}5 timestamps differ by 5 ticks or less. Thus, a theorem block may be used to assert timing behavior of a block diagram.

As used herein, a safety property states, indicates, or asserts that “the program does no harm”. A safety property can be checked on each program state in isolation, e.g., in an appropriately configured theorem block.

As used herein, a progress property states, indicates, or asserts that “the program does some good”, i.e., accomplishes something. Note that in some embodiments, a progress property can only be checked on all the states of a (partial) execution.

Thus, in various embodiments, the graphical program or block diagram may include or be coupled to a theorem block that implements an assertion regarding the behavior of the graphical program or block diagram.

In 506, a proof obligation may be generated based on the graphical program and the one or more correctness assertions, where the proof obligation is usable by a theorem prover to determine whether the graphical program is correct (or not). A proof obligation refers to a collection or set of statements which may be proved correct or incorrect, e.g., by a theorem prover, in the context of a system, in this case, a graphical program.

Note that there are a variety of different theorem provers that may be used in different embodiments of the present invention, and the particular form of the proof obligation may depend on the type of theorem prover to be used. For example, there are theorem provers that operate at different orders of mathematical logic. Thus, for example, in some embodiments, the proof obligation may be generated in or at a first order of mathematical logic, which may be usable by a first order theorem prover to prove correctness of the graphical program. Of course, in other embodiments, the proof obligation may be generated in or at higher orders of mathematical logic, e.g., second, third, fourth, and so forth, orders of mathematical logic, and so may be solvable or processed by higher order theorem provers. Note also that there are various types of proof obligation that may rely on different types of logic. For example, types of proof obligations include, but are not limited to, inductive proof obligations, based on or relying on inductive logic, and deductive proof obligations, based on or relying on deductive logic.

In embodiments where the user has specified portions of the graphical program for verification, generating the proof obligation based on the graphical program and the one or more correctness assertions may include generating the proof obligation based on the specified one or more portions of the graphical program and the one or more correctness assertions. In other words, the proof obligation may only be directed to those portions of the graphical program specified by the user.

In one embodiment, generating a proof obligation based on the graphical program and the one or more correctness assertions may include compiling the graphical program to generate an object-level diagram, parsing the one or more correctness assertions to generate an intermediate logical form of the one or more correctness assertions, and analyzing the object-level diagram and the intermediate logical form to generate the proof obligation.

As is well known, the graphical program is written in a graphical programming language, e.g., under a graphical programming development environment, such as LabVIEW, Simulink, VEE, or another graphical programming development environment, where the graphical programming language has semantics that express or govern proper or legal operations and/or constructs for programs developed in the language. In some embodiments, analyzing the object-level diagram and the intermediate logical form to generate the proof obligation may include analyzing the object-level diagram, the intermediate logical form, and an axiomatized description of semantics of the graphical programming language to generate the proof obligation. In other words, the semantics of the graphical programming language may be expressed in a form suitable for analysis, and analyzed along with the object-level diagram and the intermediate logical form to generate the proof obligation.

In 508, a theorem prover may process the proof obligation to determine program correctness, i.e., whether the graphical program is correct or not, e.g., whether the program generates the correct result, and/or operates in a correct manner. Said another way, the theorem prover may determine if the graphical program is consistent with the one or more correctness assertions. In some embodiments, the theorem prover processing the proof obligation to determine whether the graphical program is correct may include the theorem prover attempting to determine a proof of the correctness of the graphical program.

If the theorem prover fails to prove program correctness, the theorem prover may provide information indicating where the proof of program correctness failed. For example, the information indicating where the proof of program correctness failed may include information indicating that the proof of program correctness failed at a location in one or more of: the proof obligation, or the graphical program. In other words, feedback may be provided to the user indicating or hinting at where problems with the program correctness are. In some embodiments, information indicating possible avenues for correcting the graphical program may be provided. The user may then modify the graphical program and/or the correctness assertions, and repeat the above-described process as desired. The above process may thus be performed in an iterative manner until the graphical program is proven to be correct.

In some embodiments, the correctness assertions may also be included as part of the program at run-time as program assertions that must hold during execution. If an assertion fails to hold at run-time, the user may indicate that the program should stop, or the user may indicate that such a failure should be recorded in a log while the program continues to run. In some embodiments, each correctness assertion may simply be used “as is” in the graphical program. For example, if the assertions are implemented in a programming language that may be executed with the graphical program, e.g., as part of the graphical program, then no conversion may be required. Alternatively, in other embodiments, the assertions may be converted to such program code, e.g., graphical program code or text-based code, and executed with or as part of the graphical program. Note that in various embodiments, this conversion may be performed by the user, or may be performed automatically, as desired. In some embodiments, the correctness assertions may be used as run-time assertions that may be used as supplements to, or as a substitute for, formal verification by a theorem prover.

Thus, the correctness assertions of the theorem block may be included in the graphical program for run-time checking or enforcement of program behavior during execution. As noted above, in the case when a theorem of equality between the result of the program and a closed formula has been proven, it may be possible to replace the program with this closed form. In this example, the For loop could be replaced at run-time under the user's direction, with the (equivalent, but more efficient) calculation N*(N−1)/2.]

Thus, various embodiments of the systems and methods described herein may provide means for formally verifying correctness of graphical programs, and in some embodiments, may also provide for run-time checking or enforcement of specified program operation.

Although the embodiments above have been described in considerable detail, numerous variations and modifications will become apparent to those skilled in the art once the above disclosure is fully appreciated. It is intended that the following claims be interpreted to embrace all such variations and modifications.

We Claim:

1. A computer-implemented method for formal verification of a graphical program, the method comprising:
creating a graphical program in response to input, wherein the graphical program comprises a first plurality of interconnected nodes that visually indicate functionality of the graphical program;
specifying one or more correctness assertions regarding program state of the graphical program in response to user input; and
generating a proof obligation based on the graphical program and the one or more correctness assertions;
wherein the proof obligation is usable by a theorem prover to determine whether the graphical program is correct.

2. The method of claim 1, wherein said generating a proof obligation based on the graphical program and the one or more correctness assertions comprises:
compiling the graphical program to generate an object-level diagram;
parsing the one or more correctness assertions to generate an intermediate logical form of the one or more correctness assertions; and
analyzing the object-level diagram and the intermediate logical form to generate the proof obligation.

3. The method of claim 2,
wherein the graphical program is written in a graphical programming language; and
wherein said analyzing the object-level diagram and the intermediate logical form to generate the proof obligation comprises:
analyzing the object-level diagram, the intermediate logical form, and an axiomatized description of semantics of the graphical programming language to generate the proof obligation.

4. The method of claim 1, wherein the one or more correctness assertions comprise annotations in the graphical program.

5. The method of claim 1, wherein the one or more correctness assertions comprise a plurality of interconnected nodes that indicate the correctness assertions regarding program state of the graphical program.

6. The method of claim 5, wherein the plurality of interconnected notes that visually indicate functionality of the graphical program are comprised in a block diagram of the graphical program; and
wherein the plurality of interconnected nodes that indicate the correctness assertions are comprised in a theorem block comprised in or coupled to the block diagram.

7. The method of claim 1, further comprising:
a theorem prover processing the proof obligation to determine whether the graphical program is correct.

8. The method of claim 7, wherein said theorem prover processing the proof obligation to determine whether the graphical program is correct comprises the theorem prover determining if the graphical program is consistent with the one or more correctness assertions.

9. The method of claim 7, wherein said theorem prover processing the proof obligation to determine whether the graphical program is correct comprises:
the theorem prover attempting to determine a proof of the correctness of the graphical program.

10. The method of claim 9, the method further comprising:
if the theorem prover fails to prove program correctness, providing information indicating where the proof of program correctness failed.

11. The method of claim 10, wherein the information indicating where the proof of program correctness failed comprises information indicating that the proof of program correctness failed at a location in one or more of:
the proof obligation; or
the graphical program.

12. The method of claim 1, wherein the plurality of assertions specify one or more of:
invariance of one or more logical predicates regarding the graphical program;
temporal logical relationships of the graphical program;
pre-conditions of the graphical program;
post-conditions of the graphical program;
timing properties of the graphical program;
one or more safety properties of the graphical program; or
one or more progress properties of the graphical program.

13. The method of claim 1, further comprising:
incorporating the one or more correctness assertions in the graphical program, wherein the incorporated correctness assertions are executable at run-time of the graphical program to perform run-time correctness checking of the graphical program.

14. The method of claim 13, wherein said incorporating the one or more correctness assertions in the graphical program comprises:
converting the one or more correctness assertions to program code comprised in or coupled to the graphical program, wherein the program code is executable to perform said run-time checking.

15. The method of claim 13,
after said incorporating:
formally verifying the correctness assertions, wherein said formally verifying ensures that the original graphical program is equivalent to a new program having the same behavior; and
replacing the graphical program with the new program.

16. The method of claim 1, wherein the proof obligation is expressed in first order mathematical logic.

17. The method of claim 1, wherein the proof obligation is expressed in a higher order mathematical logic than first order.

18. The method of claim 1, wherein the proof obligation utilizes one or more of:
modal logic;
temporal logic;
lambda calculas; or
Hoare logic.

19. The method of claim 1, wherein the proof obligation comprises one or more of:
a number theoretic proof obligation requiring only term rewriting;
a number theoretic proof obligation requiring mathematical induction;
a list theoretic proof obligation in accordance with a formal theory of finite lists;
a temporal logic proof obligation in accordance with a formal theory of temporal logic;
a floating point proof obligation in accordance with a formal theory of floating point numbers; or
a bit vector proof obligation in accordance with a formal theory of bit vectors.

20. The method of claim 1,
wherein the graphical program further comprises a user interface portion.

21. The method of claim 1,
wherein the graphical program comprises a graphical data flow program.

22. The method of claim 1, wherein said specifying one or more correctness assertions regarding program state of the graphical program in response to user input comprises:
including a theorem block in the graphical program in response to first user input; and
including the one or more correctness assertions in the theorem block in response to second user input.

23. The method of claim 22, wherein the second user input comprises user input selecting the one or more correctness assertions from one or more of:
one or more palettes;
one or more menus; or
one or more dialogs.

24. The method of claim 22, wherein the one or more correctness assertions comprise graphical program code, comprising a second plurality of interconnected nodes that visually indicate the one or more correctness assertions, and wherein the second user input comprises user input dragging and dropping the graphical program code into the theorem block.

25. The method of claim 1, further comprising:
specifying one or more portions of the graphical program to verify in response to user input;
wherein said generating a proof obligation based on the graphical program and the one or more correctness assertions comprises generating the proof obligation based on the specified one or more portions of the graphical program and the one or more correctness assertions.

26. A computer-readable memory medium that stores program instructions for formal verification of a graphical program, wherein the program instructions are executable by a processor to perform:
creating a graphical program in response to input, wherein the graphical program comprises a first plurality of interconnected nodes that visually indicate functionality of the graphical program;
specifying one or more correctness assertions regarding program state of the graphical program in response to user input; and
generating a proof obligation based on the graphical program and the one or more correctness assertions;
wherein the proof obligation is usable by a theorem prover to determine whether the graphical program is correct.

27. A system for formal verification of a graphical program, comprising:
a processor; and
a memory medium coupled to the processor, wherein the memory medium stores program instructions for formal verification of a graphical program, wherein the program instructions are executable by the processor to:
create a graphical program in response to input, wherein the graphical program comprises a first plurality of interconnected nodes that visually indicate functionality of the graphical program;
specify one or more correctness assertions regarding program state of the graphical program in response to user input; and
generate a proof obligation based on the graphical program and the one or more correctness assertions;
wherein the proof obligation is usable by a theorem prover to determine whether the graphical program is correct.
